(19) United States
(12) Patent Application Publication
(10) Pub. No.: US 2013/0096467 A1
(43) Pub. Date: Apr. 18, 2013

(54) Tension Release Technique

(71) Applicant: Joseph Jacobs, Nashville, TN (US)

(72) Inventor: Joseph Jacobs, Nashville, TN (US)

(21) Appl. No.: 13/317,234

(22) Filed: Oct. 13, 2011

(51) Int. Cl. A61H 1/00

(52) U.S. Cl. 601/1

(57) ABSTRACT

The present invention is a manual, medicine, therapy technique that provides a guide to evaluate soft tissue impairment and guidelines to treat muscle tension, muscle pain, soft tissue pain, trigger points, and tension headaches through stimulating the Golgi Tendon Organs.

### BACKGROUND OF THE INVENTION

1. Field of the Invention

The invention relates generally to manual medicine to evaluate soft tissue impairment and treat patients who have impaired movement of upper and lower extremities, along with the neck, head and back. The current invention could be used by the following individuals to treat patients: physical and occupational therapists, medical and osteopathic doctors, nurses, athletic trainers, massage therapists and chiropractors.

2. Description of the Prior Art

Pain Cycle: The human body can experience injuries in a variety of ways. Accidents, fails, poor body mechanics, poor posture, and age related degeneration name just a few of these causes. When one of these takes place, the body's central nervous system, which consists of the brain and spinal cord, receives a pain message, detected by pain, nerve receptors called nociceptors. The nervous system attempts to protect the injured location by sending a signal to the surrounding muscle to guard itself and sustain a static position to avoid shear force. The goal of this mechanism is to prevent excessive movement in the injured location to avoid further damage. The surrounding muscle is forced to work hard to protect the injured area, which increases muscle tension and causes micro-tears in the soft tissue, which causes a contracture. A contracture is the shortening of a soft tissue and could occur in a muscle, tendon, ligament, or fasciae. Long term contractures cause adhesions, scar tissue, and loss of joint range of motion. This phenomena causes pain, which sends a signal to the nervous system and increases muscle activity to guard and protect the injured site. Constant activity of the muscle causes more pain, which continues the pain cycle. In order to break the pain cycle, an external intervention must be introduced to stimulate the Golgi Tendon Organs, in order to decrease muscle tension.

Every muscle has many sensory receptors called the Golgi Tendon Organs (GTO's). The GTO's are located near the muscle tendon junction. The GTO's function is to decrease muscle tension and promote muscle relaxation. In addition to GTO's, each muscle has neurons called alpha motorneurons that are attached to the muscle's fibers. They stimulate muscle activity and increase muscle tension. When the muscle becomes tense, the GTO's fire to prevent the alpha motorneurons from stimulating the muscle, which in turn decreases muscle tension and promotes relaxation. The two work to balance muscle activity. Another way to look at this is to imagine that the muscle has two switches. One switch (alpha motorneurons) turns the muscle on and the other switch (GTO's) turns the muscle off. For example, if a person sits hunched over his/her computer every day for hours, the alpha motorneuron switch is continually on and their nervous system adapts to their improper posture, which continually stimulates the alpha motorneurons; not allowing the neck muscle to relax.

Massage, trigger point release, strain/counterstrain (positional release technique), muscle energy technique and myofascial release name just a few of the manual, medicine, therapy techniques that are currently being used in physical therapy to relieve soft tissue pain. Unfortunately, these techniques do not address the Golgi Tendon Organs ability to relieve pain and promote relaxation. Most of these techniques require gliding, traction, and increased muscle tension. Many patients are unable to tolerate these techniques because they increase tissue inflammation and cause excessive stimulation of the alpha motorneurons, which in turn, stimulates the pain cycle. There is a need for a non-invasive, manual, medicine technique that activates the Golgi Tendon Organ without stimulating the alpha motorneurons. At the same time, this technique should not cause gliding or resistance to soft tissue because it could increase muscle tension and pain.

### REFERENCES

“Physical Rehabilitation. 5th edition;” O'Sullivan S & Schmitz T. F. A. Davis, Jaypee. 2007.

“National Physical Therapy Examination: Review & Study Guide;” O'Sullivan S & Siegelman R. TherapyEd 2010.

“Therapeutic Exercise: Foundations and Techniques. 5th edition;” Kisner C & Colby L. F. A. Davis 2007.

“Pathology. Implication for the Physical Therapy. 2nd edition;” Goodman, Fuller & Boissonnault. Saunders An Imprint of Elsevier 2003.

“Barr's the Human Nervous System: An Anatomical Viewpoint. 8th edition;” Kiernan J. Lippincott Williams & Wilkins 2005.

“Principles of Manual Medicine. 3rd edition;” Lippincott Williams & Wilkins 2003.

“Neuroanatomy: An Atlas of Structures, Sections, and Systems. 6th edition;” Haines D. Lippincott Williams & Wilkins 2004.

“Pharmacology in Rehabilitation: Notes” Deborah A. Deluca. Dominican College 2009.

“Advance Clinical Seminar; Powerpoint” Michella K. Dominican College 2009.

“J Physiology” Prochazka A & Gorassini M 1998.

“Neurophysiolgy” Prochazka A, Gillard D & Bennett D 1997.

### OBJECTS AND SUMMARY OF THE INVENTION

The primary object of the present invention is to provide clinicians with a non-invasive, manual medicine therapy technique to relieve trigger points, muscle tension, muscle and soft tissue pain, and tension headaches.

Another object of this invention is to provide clinicians with a systematic, assessment tool to evaluate soft tissue impairment prior to treatment.

It is a further object of this invention to provide clinicians with specific treatment protocols for various, soft tissue impairments.

The present invention is a manual, medicine, therapy technique that provides a guide to evaluate soft tissue impairment and guidelines to treat muscle tension, soft tissue pain, trigger points, and tension headaches through stimulating the Golgi Tendon Organs.

### BRIEF DESCRIPTION OF DRAWINGS

FIG. 1 is a side view of the supine treatment position with pillows under knees and head

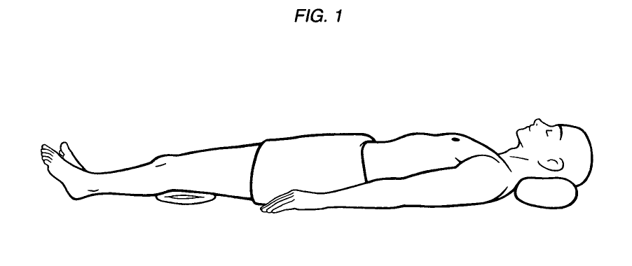

FIG. 2 is a side view of the side laying treatment position with pillows between knees, under head and in between arms

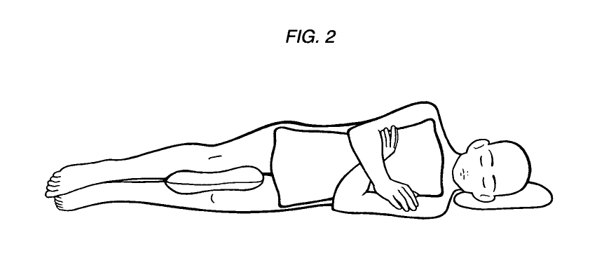

FIG. 3 is a side view of the sitting treatment position on chair and pillow over thighs

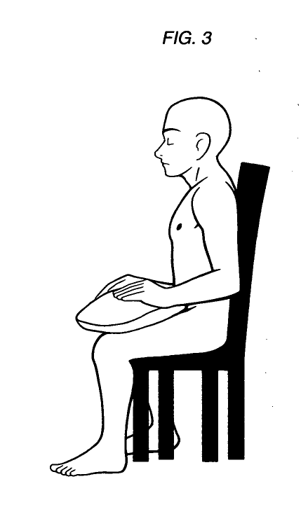

FIG. 4 is a skyline or top view of the treating hands position for the temporalis muscles

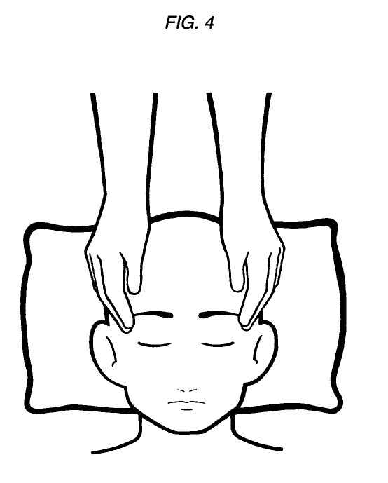

FIG. 5 is a back view of the treating hands position for the lower trapezius, rhomboid, infraspinatus muscles

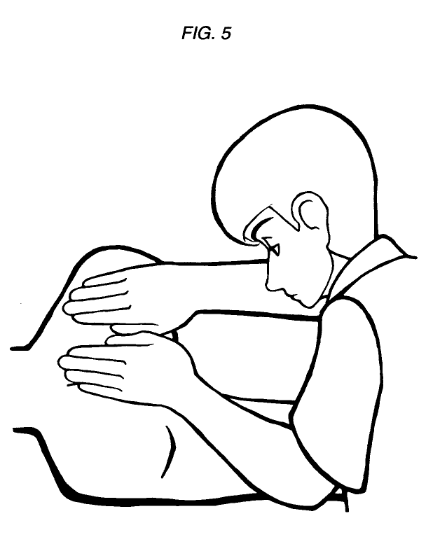

FIG. 6 is a back view of the treating hands position for part of the latissimus dorsi muscle

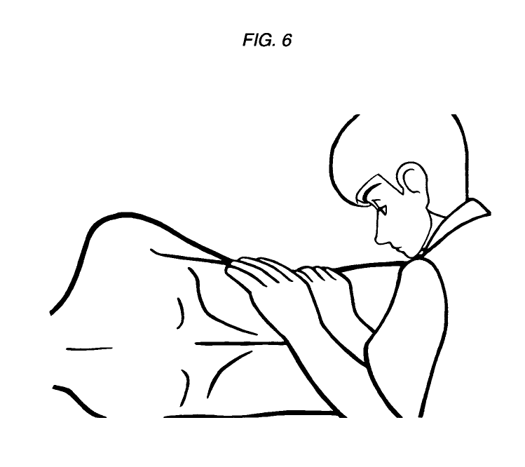

FIG. 7 is a side view of the treating hands position for the iliotibial tract and vastus lateralis

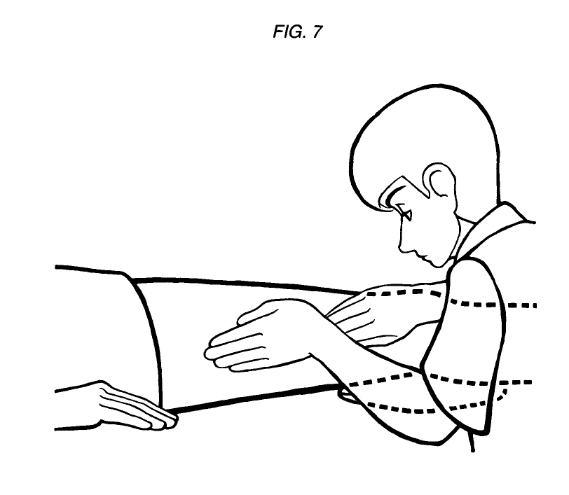

FIG. 8 is a skyline or top view of the treating hands position for the frontalis muscle

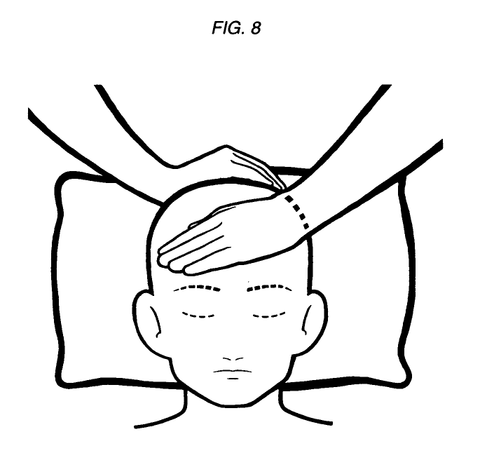

### DETAILED DESCRIPTION OF THE INVENTION

### The Drawings

The drawings provide a generalized guideline for some of the treatment positions. The present invention may be used for the majority of the body's muscles. The present invention is not limited to the sample drawings provided. Through integrating the knowledge of the body's anatomy and the principle of the present invention, clinicians should be able to provide hand positions for the majority of the body muscles that need treatment. Clinicians should be aware of each muscle attachment in order to treat patients affectively. Clinician's hands should cover the painful area of the muscle, while applying light pressure to the muscle tendon junction simultaneously, in order to stimulate the GTO's .

### Evaluation Procedure:

The clinician should follow the following procedures to evaluate soft tissue impairments:
A.) Ask the patient the following questions and keep a record of their answers: 1) Where are you experiencing the most amount of pain? 2) Is the pain sharp, numb, ache, dull, sore, throbbing, or tingling? 3) Do you have a headache? 4) On a scale of 0 to 10, (0=No Pain, 10=Very Painful) how much pain do you feel in the most uncomfortable area?
B.) The clinician should palpate the painful, soft tissue in order to identify the type of impairment. The following are various types of impairments that could be treated using the present invention:
   1. Increased muscle tone/pain: in order to determine the muscle's tone, the therapist should use the Modified Ashworth Scale, which assesses muscle spasticity on a grade of 0 to 4. An individual, at grade 0, has a completely relaxed muscle. A relaxed muscle will be soft, pliable, and very easy to manipulate. On the other hand, a stroke patient, at grade 4, will have a very rigid and stagnant muscle. The present invention is affective with grade 1 patients only. Individuals with grade 1 will have a “slight increase in muscle tone and have minimal resistance at the end of the joint range of motion.” When the clinician palpates the muscle, they should feel a hard, tight band of muscle fibers.
   2. Trigger Points: according to Travell, trigger points are small, contraction knots in muscle tissue. When palpated, they feel like nodules of condensed tissue.
   3. Tension (Cerviogenic) Headaches: are associated with increased muscle contractions and are generally a response to stress, anxiety, abnormal neck and back posture, and disorders of the cervical spine and atlantooccipital joints. One of the causes of tension headaches is a spasm of the posterior neck and percranial muscles. It is a very common type of headache in geriatric patients because of arthritic change in their cervical vertebrae. Tension headaches usually radiate to the neck and shoulders. Patients usually complain of pain and tenderness in the forehead, temples, back of the head, and neck.

### Treatment Positions:

1. Supine position: using the treatment table, patient should lay on their back in a comfortable position. With one or two pillows under their head, clinician should ensure that the patient's neck is in a neutral position. No excessive neck flexion, extension, rotation, or side bend should occur. Another pillow should be placed under the patient's knee to avoid back muscle strain. The patient's arms should be at their side or on their stomach. This position is used when treating the following areas: head, neck, cervical muscular, trigger points in upper trapezius, bilateral shoulders, arms, forearms, anterior/medial lateral thigh, anterior/medial/lateral leg, foot, and ankle.
2. Side laying position: using the treatment table, patient should lay on the side that isn't painful. The patient should be very comfortable. With one or two pillows under the head, clinician should ensure that the patient's neck is in a neutral position. No excessive neck flexion, extension, rotation or side bend should occur. Another pillow should be placed between the patient's knees. Bilateral hip, knee, and ankle should be aligned with no trunk rotation. Another pillow should be given to the patient to hug in order to avoid any trunk rotation and to keep the shoulder girdle in a neutral position. This position is used when treating the following areas: back, trigger points in middle trapezius, shoulder, arm, forearm, pelvis, anterior/posterior/lateral thigh, anterior/posterior/lateral leg, foot, and ankle.
3. Sitting position: sitting in a comfortable chair, patient's neck should be in a neutral position with their back supported by the chair with their hip and knee at 90 degrees flexion and ankle supported on floor with 0 degree dorsiflexion. Patient should have a pillow on their lap to support bilateral upper extremity. It is suggested that clinicians use the supine and side-lying positions to maximize patient comfort. Different clinical trials showed better outcomes when patient's were treated in either the supine or side-lying positions.

### Treatment Protocols:

1. Treating increased muscle tension or tone/muscle pain: 1) ask patient to identify the most painful area. 2) ask patient on a scale of 0 to 10, (0=No Pain, 10=Very Painful) how much pain they feel. 3) choose appropriate, treatment position for patient and make sure that they are in a relaxed state. 4) apply static, light pressure over the painful muscle, including the muscle tendon junction, in order to stimulate the Golgi Tendon Organs. 5) patient should indicate when the pain level starts to decrease 6) maintain static, relaxed hands with light pressure over the treated area until the pain level disappears. It usually takes 90 seconds to 5 minutes to treat one area.
* Note: The current invention is not intended to treat tender points.
2. Treating trigger points: 1) identify the muscle or muscle group of the trigger point. (Clinician should know the muscle origin and insertion in order to provide proper treatment.) 2) choose appropriate treatment position for patient and make sure that they are in a relaxed state. 3) estimate the size of the trigger points. Trigger points that are larger than ½ inch may require treatment times lasting as long as 15 minutes. Those less than ½ inch normally dissolve within 3 to 5 minutes. 4) apply light, static pressure over the trigger point muscle or muscle group including the origin and insertion of the muscle to the bone. Please note, If the muscle is contracted and not relaxed, the treatment will not be effective.
3. Treating tension (cerviogenic) headaches: 1) ask patient to identify the most painful/tense area in the neck or head. 2) ask patient on a scale of 0 to 10, (0=No Pain, 10=Very Painful) how much pain they feel. 3) choose appropriate, treatment position for patient and make sure that they are in a relaxed state. 4) apply static, light pressure over the painful muscle, including the muscle tendon junction, in order to stimulate the Golgi Tendon Organs. 5) patient should indicate when the pain level starts to decrease 6) maintain static, relaxed hands with light pressure over the treated area until the pain level disappears. It usually takes 90 seconds to 5 minutes to treat one area. 7) continue treating other related areas from most painful to least until the headache is gone. Use the same protocol with each treatment.

### Manual Therapy Technique

The present invention is dependent on the effect of pressure from one's hands. When pressure from one's hands is sustained over a muscle tendon junction for a period of time, it activates the Golgi Tendon Organs, which stops alpha motorneurons and decreases muscle tension. This promotes soft tissue relaxation and increases blood flow circulation, which allows the tissue to repair and heal. Clinicians should be aware of each muscle attachment in order to treat patients affectively. Clinician's hands should cover the painful area of the muscle, while applying pressure over the muscle tendon junction simultaneously, in order to stimulate the GTO's.

### Applications of Current Invention

In general, this invention helps relieve soft tissue pain and decreases symptoms associated with, but not limited to, the following diagnoses: neck pain, back pain, hip pain, knee pain, ankle pain, shoulder pain, elbow pain, wrist pain, hand pain, trigger points, tension (cerviogenic) headaches, post surgery pain, chronic pain syndrome, lumbar stenosis, bursitis, tendonitis, ligament sprains, muscle strains, spondylosis, degenerative disc disease, degenerative joint disease, acute pain, arthritis, rheumatoid arthritis, plantar fasciitis, osteoarthritis, chronic pain, facet joints syndrome, muscle tightness, increased muscle tension, epicondyliltis, soft tissue pain, motor vehicle accident pain, fibromyalgia, TMJ capsule locking (catching), and TMJ pain.

### Treatment Outcome

The following are some of the treatment outcomes: relieves muscle pain and tension headaches; promotes muscle relaxation for treated areas; increases flexibility, joint range of motion, muscle strength, and blood circulation; decreases muscle hypertonicity, fascia tension, muscle spasms, and scar tissue; breaks down trigger points.

1. The methods and procedures to evaluate and treat the following soft tissue impairments:
a. Tension (Cerviogenic) headaches
b. Muscle and soft tissue tension/pain
c. Trigger points

2. The method of claim 1 further comprising the performance of the manual therapy Technique, which stimulates the Golgi Tendon Organs in order to treat the following conditions:
a. Tension (Cerviogenic) headaches
b. Muscle and soft tissue tension/pain
c. Trigger points

3. A method of claim 2 further comprising the guidelines for patient, treatment positioning:
a. Supine position
b. Side-lying position
c. Sitting position
